(19) United States
(12) Patent Application Publication
(10) Pub. No.: US 2018/0044846 A1
(43) Pub. Date: Feb. 15, 2018

(54) Method For Improving Adhesion Between A Reinforcement Element And An Elastomer Matrix Material

(71) Applicant: Continental Reifen Deutschland GmbH, Hannover (DE)

(72) Inventors: Thomas Kramer, Herford (DE); Claudia Grote, Hannover (DE); Eberhard Janssen, Düren (DE); Maike Rabe, Neuss (DE); Kristina Klinkhammer, Aachen (DE); Esther Rohleder, Mönchengladbach (DE)

(73) Assignee: Continental Reifen Deutschland GmbH, Hannover (DE)

(21) Appl. No.: 15/550,799

(22) PCT Filed: Feb. 16, 2016
(86) PCT No.: PCT/EP2016/000256

§ 371 Date: Aug. 14, 2017

(30) Foreign Application Priority Data
Feb. 18, 2015 (DE) 10 2015 001 902.3

(51) Int. Cl. D06M 10/02; D06M 15/356; C08J 5/04; B60C 9/00; C08J 5/06; D06M 10/10; B29D 30/40

(52) U.S. Cl. CPC D06M 10/025; D06M 10/10; D06M 15/3562; B29D 30/40; B60C 9/0042; C08J 5/06; C08J 5/046; D06M 2400/02; B29D 2030/383

(57) ABSTRACT

The invention relates to a method for improving adhesion between a reinforcement element that comprises textile fibers or textile filaments and an elastomer matrix material, in particular uncured rubber, the reinforcement element being provided with a sol-gel coating and the sol-gel coated reinforcement element being exposed to the action of a plasma, in particular a low-pressure plasma.

The invention relates to a process for improving the adhesion between a reinforcing element, in particular a textile reinforcing element comprising fibers and an elastomeric matrix material, in particular a rubber or a rubber mixture, where the reinforcing element is subsequently to be embedded into the matrix material or at least to be coated therewith. The invention in particular relates to a process for the coating of a reinforcing element for the purpose of adhesion improvement.

It is known in the prior art that it is difficult to achieve long-term coating of reinforcing elements by an elastomeric material or embedment of said elements into said material for reinforcement purposes. This is a result by way of example of very different modulus of elasticity values of the two materials to be bonded, and also of different surface chemistry.

This problem is particularly apparent in the tire production sector where adhesion is required between an elastomeric rubber matrix material of the tire and the metallic, or very particularly the textile, tire cords provided as reinforcing elements therein. The term rubber here and in the description of the invention hereinafter means natural rubber and also synthetically produced rubber, and also rubber mixtures and filled rubber mixtures.

The traditional prior art uses adhesion promoters to improve the adhesion between the different materials. An example of a known procedure in the tire-production sector is known as RFL dip, where the reinforcing elements—generally textile cords—are coated with a mixture of resorcinol/formaldehyde and latex.

Resorcinol and formaldehyde are potentially hazardous to health and to the environment, and in principle therefore efforts are being made to discover alternatives for improving adhesion, but these have not hitherto provided sufficiently satisfactory results.

It is therefore an object of the invention to provide a process which can improve the adhesion between elastomeric matrix materials, e.g. rubber, and reinforcing elements, in particular while avoiding use of resorcinol and formaldehyde.

A particular objective is to improve the adhesion of elastomeric matrix materials, for example synthetic or natural rubber, or in particular filled rubber mixtures, on textile fibers and woven fabrics, in particular on textile cords. The term cords here means twisted threads/filaments. A particular intention is to achieve an adhesion improvement for textile cords made of polymer fibers, for example made of polyester or of polyamides, with the particular objective of permitting use of these in tire production.

Although the field of tire production is specified as preferred, the invention is not restricted thereto. The use of the invention for textile fibers is likewise merely preferred, with no restriction thereto, and no restriction to textile reinforcing elements.

By way of example, the invention is intended to permit treatment of metallic elements, and preferably also metallic cords, in order to improve the adhesion of these elements on elastomeric matrix materials.

For the purposes of the invention, an adhesion improvement is considered to have been achieved if adhesion is better after inventive treatment of the reinforcing element by the process described hereinafter than for an untreated reinforcing element, and very particularly if the adhesion is better after inventive treatment than after a traditional treatment of a reinforcing element with an RFL dip.

Said object is achieved in the invention in that a sol-gel coating is provided to the reinforcing element and the sol-gel-coated reinforcing element is exposed to the action of a plasma, in particular of a low-pressure plasma.

Preferred low-pressure plasma means a plasma that is present under pressure conditions at least below the normal local ambient atmospheric pressure, i.e. generally pressures below 1000 mbar.

In comparison with a plasma under ambient atmospheric pressure, in particular in the range of 1000+/—100 mbar, the low-pressure plasma in the pressure range therebelow has the advantage that less fiber damage results from the action of the plasma.

The process is preferably carried out at pressures below 2 mbar, and in particular this also has the concomitant advantage of low gas consumption. A particularly preferred pressure range of the plasma in a plasma chamber or a plasma zone of a plasma chamber is from 0.5 mbar to 1.5 mbar.

Surprisingly, it has been found that action of a plasma on a sol-gel-coated reinforcing element leads to an adhesion improvement in comparison with a sol-gel coating alone; an impartial person skilled in the art would initially have expected that the action of the plasma would cause removal of the organic constituent of a sol-gel layer by what is known as plasma etching, since plasmas are known to the effective in the cleaning of surfaces before subsequent coating processes.

However, contrary to expectation, it has been found that the adhesion properties of the sol-gel layer after plasma treatment of a sol-gel-coated reinforcing element are different, and significantly more advantageous, than those of, for example, a sol-gel layer that has merely been oven-dried.

The invention can preferably provide that the manner of sol-gel coating here is such that the coating procedure leads to a solid coating which, in particular based on the weight of the uncoated reinforcing element, amounts to from 0.02 to 5 percent by weight, more preferably from 1 to 2.5 percent by weight, on the reinforcing element. The sol-gel-coating process is a process known per se in the prior art in which a coating made of colloidal dispersion of precursors, in particular with nanoparticulate constituents, is produced, where gelling takes place via onset of hydrolysis of the mixed precursors, condensation and polycondensation, and the

A resultant gel is then dried. possible embodiment of the invention can provide that the reinforcing element is first subjected to the sol-gel-coating process before action of a plasma, and that for this purpose by way of example at least one dispersed precursor is applied in conventional manner to the surface of a reinforcing element. It can then be provided that polymerization, hydrolysis and condensation of the sol-gel layer first take place, optionally with thermal acceleration outside of a plasma, e.g. in an oven, before a plasma is used to post-treat the resultant sol-gel layer.

Another embodiment can also provide that before action of a plasma the reinforcing element is subjected to the sol-gel-coating process, and for this purpose by way of example at least one dispersed precursor is applied in conventional manner to the surface of a reinforcing element, and that then the action of the plasma at least initiates hydrolysis and/or the polymerization and/or condensation of the sol-gel after application thereof on the reinforcing element, and in particular action of the plasma continues during the entire polymerization and/or condensation and/or hydrolysis of the sol-gel. In particular, it can also be provided that the resultant gel is dried with action of the plasma.

It can likewise be provided that the coating of the reinforcing element with a sol-gel or the dispersed precursors takes place at the same time as the action of the plasma, in particular in that the sol-gel materials are applied to the reinforcing element via spraying into the plasma, for example into a plasma zone in a reaction chamber by means of a nozzle. It is also possible that at least the initiation of the polymerization and/or condensation and/or hydrolysis of the sol-gel materials in the plasma follow(s) this procedure, or that completion thereof follows this procedure.

In all possible process variants, in particular those mentioned above, it can also be provided that before an application of the sol-gel materials the reinforcing element to be coated is pretreated in a plasma, for example for cleaning purposes.

In all possible process variants, in particular those mentioned above, it can moreover be provided that the plasma temperature selected is above the glass transition temperature of the material of the reinforcing element to be coated. This is particularly appropriate when the reinforcing material is semicrystalline, for example is a plastic, e.g. polyester, and particularly fibers or cords made of said material.

The plasma temperature selected is preferably selected in the range from 100 degrees Celsius to 150 degrees Celsius, in particular when polyethylene terephthalate is used. The range utilized is therefore not expected to result in any thermal damage to the reinforcing-element material or to the sol-gel constituents.

The invention can provide that a reinforcing element is treated by the process in a plasma chamber, in particular subatmospheric-pressure chamber, in which the plasma is ignited and maintained for the duration of a desired treatment, e.g. preferably for from 10 to 120 seconds.

It is possible to undertake not only batch processes but also roll-to-roll treatment of “continuous” reinforcing elements, e.g. cords, these taking the form of flexible strand or web material when they are passed through the plasma, as is the case by way of example when, for example, textile tire cords or other cords, or woven cord fabrics, are involved.

It is possible here that an unwind package or unwind roll and a wind-up package or wind-up roll are provided respectively in the plasma chamber or subatmospheric pressure chamber, or alternatively that said packages are positioned outside of the plasma chamber and that the reinforcing element in the form of strand or of web is passed through an airlock region between chamber and winder, so that although the material is stored outside of the chamber it is treated by plasma at subatmospheric pressure within the plasma chamber.

The invention can provide that an unwind device supporting a package is subjected to braking during unwind, in particular subjected to force-controlled braking, in particular in order to prevent shrinkage of the reinforcing element in the plasma.

In particular when the packages or rolls are stored outside of a chamber, it is advantageous to select, as gas composition for the plasma, the composition of the natural ambient atmosphere; it is thus possible to make direct use of said atmosphere.

The gas selected as process gas for the purposes of carrying out the process in the invention can, in the simplest and least expensive case, be air. Preference is further given to use of, for example, oxygen, nitrogen or noble gases, such as argon, or else a mixture of these or other gases.

In every case, the inventive treatment is carried out at least along a portion of the entire extent of the at least one strand, between unwind of at least one strand of a reinforcing element from at least one unwind package and wind-up of same on at least one wind-up package.

For generation of the plasma it can be provided that at least one microwave generator, radio-frequency generator or kilohertz generator is used, operating by way of example with generator power values in the range of 20 to 200 watts/liter of reactor volume, preferably from 60 to 120 watts/liter. Plasma parameters selected here, in particular physical plasma parameters, are preferably appropriate for the reactivity of the gas(es) used, or dependent thereon.

Insofar as coating of the reinforcing element does not take place with the action of a plasma, as in the case by way of example when material is sprayed into the reaction chamber by means of a nozzle, or takes place via an aerosol sprayed onto the reinforcing element with action of a plasma, it can be provided that the sol-gel coating is provided to the reinforcing element before entry into a plasma chamber, optionally after a prior plasma treatment, for example for the purpose of cleaning.

This means at least the application of the precursors, i.e. of the as yet uncrossed sol-gel constituents, but then also the completion of the sol-gel coating at least as far as the conclusion of polycondensation and with further preference inclusion of drying.

It is possible that a reinforcing element, in particular textile reinforcing element, is coated by way of example before introduction to the plasma chamber, e.g. via passage through a bath of the sol-gel materials. Particularly when textile reinforcing elements are used, for example tire cords, a Foulard rig, installed upstream of the plasma chamber, can be used for the coating process. In particular when this type of machine is used, the coating process can be integrated into the roll-to-roll process.

The invention can provide that the plasma is divided into one or more different plasma zones in particular where physical and/or chemical parameters of the plasma differ in the various zones. For this purpose it is possible by way of example that a plasma chamber has different chamber regions, and that in particular these are in turn separated from one another by airlock regions in which the different parameters are established, and in particular controlled.

Differently selected parameters can by way of example be physical or chemical parameters, e.g. the plasma temperature, the pressure, or else the gas composition in the plasma. It is thus possible to carry out a first type of treatment in a first plasma zone with a first parameter set applied to a selected plasma, and to carry out an appropriately different treatment in another plasma zone with another parameter set. By way of example, it is possible that the application of the sol-gel materials takes place in a first zone via spraying into the reaction chamber by means of a nozzle, and that a drying procedure and/or a desired functionalization of the sol-gel layer takes place in at least one subsequent zone.

In the case of all uses and possible embodiments it can moreover be provided that the action of the plasma on the sol-gel-coated reinforcing element has been selected in a manner that prevents the production of a ceramic/glassy film on the reinforcing element. By way of example the exposure time in a zone, or else the total period of action across all zones, can be selected to be shorter than the time required to produce a ceramic/glassy layer from the sol-gel layer.

The invention can provide that at least one precursor or mixture of a plurality of precursors is used to form the sol-gel coating. The at least one precursor, or the precursors of a mixture, has/have a chemical structure that permits construction of a polymer film with a hybrid structure. The precursors here comprise first functional groups which develop, via hydrolysis and condensation, an inorganic network among themselves or with respect to the elastomeric matrix material. The precursors moreover comprise second functional groups which develop an organic network among themselves and/or with respect to the elastomeric matrix material that is subsequently to form a superposed layer.

The hydrolysable/condensable first groups can comprise from one to three alkoxy groups, in particular ethoxy groups and/or methoxy groups. The second type of functional groups can comprise vinyl groups, amino groups, glycidoxy groups and mercapto groups.

Compounds that can therefore preferably be used to form the sol-gel are alkoxysiloxanes which have the general structure R(R′)—Si—X₂ or R—Si—X₃, where X=hydrolyzable alkoxy groups, preferably methoxy group or ethoxy group, and which crosslink and improve the adhesion to the reinforcing element.

The moiety R can bring about a variety of functionality of the reinforcing element, in particular on a textile cord, and in particular here can improve the adhesion to the elastomeric matrix. Functional groups that can be used here are by way of example amino groups, vinyl groups, acryloxy groups, mercapto groups, sulfur-containing groups or epoxy groups.

Particularly when a plurality of different precursors are used to form a sol-gel coating for the reinforcing element, it can be provided that said precursors are applied in the form of finished mixture or else alternatively are applied in a multistage application process, in particular in succession. A mixture can comprise various precursors, or groups of precursors, in a ratio of 1:1 to 1:50, preferably 1:1 to 3:7.

An embodiment can also provide that latex, in particular vinyl pyridine latex, is applied to the reinforcing element, and in particular is applied as single layer following the sol-gel-coating process or as constituent in a mixture of a plurality of precursors of the sol-gel. The ratio of latex to the entirety of the (other) precursors can preferably be from 1:1 to 1:50, preferably from 1:2 to 1:4.

The process described above can particularly preferably be used for the pretreatment of textile reinforcing elements, in particular textile tire cords comprising fibers and/or woven fabric, in particular textile polymer tire cords for subsequent coating with rubber or rubber mixtures, including filled rubber mixtures. Textile fiber elements for use in the invention can generally be composed of a thread or else two or more twisted, braided or woven threads, where each thread comprises a plurality of fibers or filaments.

The reinforcing elements comprise by way of example: polyamide, polyester, aromatic polyester or aromatic polyamide, polyvinyl alcohol, polyetheretherketones, polyethylene, polypropylene, or cotton, cellulose, carbon fibers, glass fibers and/or hybrid cord. The term hybrid cord means a twisted textile fiber element whose fibers are composed of at least two different materials. In this use, and in general, the pretreatment of the invention can introduce functional groups up to the surface of the reinforcing element or the sol-gel layer thereof, examples being oxygen radicals, ozone, amino functions, etc., in particular groups which provide specific possibilities of reaction with the elastomeric matrix material.

By way of example, inventive pretreatment and subsequent coating with elastomeric matrix material or embedment into same can lead to interpenetration between the elastomeric matrix material, in particular the rubber, and functional groups that have been produced in the sol-gel coating via the plasma treatment, with resultant covalent bonding between sol-gel and elastomer matrix.

The favorable effects of the process of the invention have been confirmed experimentally. Adhesion forces (N, newtons) between tire cords and a commercially available rubber mixture are listed below for woven tire cord fabric in test samples of width 25 mm which have two mutually superposed plies of tire cord across the entire test sample width and a bilateral coating of matrix material of thickness 0.4 mm, for various types of adhesion-improving treatment. Each of the sol-gel precursors used is mentioned in the example.

The adhesion forces were determined in accordance with ISO 36:2011 (E), and adhesion tests, known as Peel tests, were carried out here with the differently treated cords, with evaluation in accordance with DIN ISO 6133, without aging.

Cord used in the test samples was polyester PET 1440×1×2 370 tpm (turns per meter) produced by Performance Fibers. Samples B and D were dried at 120° C. for 3 minutes in a conventional laboratory dryer. A low-pressure plasma system was used for the production of samples C and E. Air was selected as process gas, and the residence time was 15 seconds. The power value used is stated below.

Sample A: untreated polyester cord: 106 N

Sample B: polyester cord A treated with respectively 2% of mercaptopropyltrimethoxysilane and aminosilane, drying and condensation in a drying oven: 107 N

Sample C: as B, but plasma treatment of the invention 160 W: 148 N

Sample D: polyester cord A treated with 7% of aminosilane solution and 3% of latex, drying and condensation in a drying cabinet: 163 N

Sample E: as D, but plasma treatment of the invention 200 W: 196 N

Sample F: polyester cord A having a coating with RFL dip by standard process; process standard: 185 N. Described by way of example in R. B. Durairaj, Resorcinol, Chemistry, Technology and Applications; Springer Verlag 2005. In the chapter relating to polyester adhesion (6.3 et seq.).

It has been found that the process of the invention improves adhesion of the rubber matrix not only when comparison is made with untreated cords but also when comparison is made with oven drying used as alternative with identical sol-gel coating materials.

1.-13. (canceled)

14. A method comprising:
a. applying a sol-gel coating to a reinforcing element to provide a sol-gel-coated reinforcing element; and,
b. exposing the sol-gel-coated reinforcing element to a plasma action;
wherein adhesion force between the sol-gel-coated reinforcing element and an elastomeric matrix material is higher than adhesion force between an uncoated reinforcing element and the elastomeric matrix.

15. The method according to claim 14, wherein the reinforcing element comprises textile fibers.

16. The method according to claim 14, wherein the reinforcing element comprises textile filaments.

17. The method according to claim 14, wherein the elastomeric matrix material is rubber.

18. The method according to claim 14, wherein the plasma action is provided by a low-pressure plasma.

19. The method according to claim 14, wherein the sol-gel coating provides a solid coating, and wherein the sol-gel coating is from 0.02 to 5 percent based on weight of the reinforcing element.

20. The method according to claim 19, wherein the sol-gel coating is from 1 to 2.5 percent based on weight of the reinforcing element.

21. The method according to claim 14, wherein the reinforcing element is a textile fiber element comprising polyamide, polyester, aromatic polyester, aromatic polyamide, polyvinyl alcohol, polyetheretherketones, polyethylene, polypropylene, polyethylene terephthalate, cotton, cellulose, carbon fibers, glass fibers and/or hybrid cord.

22. The method according to claim 14, wherein the applying a sol-gel coating to the reinforcing element takes place before the exposing the sol-gel-coated reinforcing element to the plasma action.

23. The method according to claim 14, wherein the applying a sol-gel coating to the reinforcing element takes place at the same time as the exposing the sol-gel-coated reinforcing element to the plasma action.

24. The method according to claim 14, wherein the applying a sol-gel coating to the reinforcing element comprises spraying the sol-gel coating into plasma used for the plasma action.

25. The method according to claim 14, wherein the applying a sol-gel coating to the reinforcing element comprises spraying the sol-gel coating into a zone used for the plasma action.

26. The method according to claim 14, wherein the plasma action at least initiates polymerization and/or condensation of the sol-gel coating after applying the sol-gel coating to the reinforcing element.

27. The method according to claim 26, wherein the plasma action continues during the polymerization and/or condensation of the sol-gel coating.

28. The method according to claim 14, wherein the reinforcing element comprises a material having a glass transition temperature, and wherein the plasma action is performed at a temperature above the glass transition temperature of the material comprised in the reinforcing element.

29. The method according to claim 14, wherein the plasma action is performed in a plurality of plasma zones, and wherein physical and/or chemical parameters of the plasma action differs amongst the plurality of plasma zones.

30. The method according to claim 14, wherein the plasma action is performed over time range which is less than a time required to produce a ceramic/glassy film on the sol-gel-coated reinforcing element.

31. The method according to claim 14, wherein the sol-gel coating comprises at least one or more precursors, wherein the at least one or more precursors comprises hydrolyzable and condensable first functional groups which develop an inorganic network among themselves and/or with respect to the elastomeric matrix material, wherein the sol-gel coating comprises second functional groups which develop an organic network among themselves and/or with respect to the elastomeric matrix material, and wherein the one or more precursors promotes a hybrid structure within the sol-gel coating.

32. The method according to claim 31, wherein the first functional groups comprises a plurality of alkoxy groups, and wherein the second type of functional groups comprises vinyl groups, amino groups, glycidoxy groups and mercapto groups.

33. The method according to claim 14, wherein a vinyl pyridine latex is applied to the reinforcing element.
